(19) United States
(12) Patent Application Publication
(10) Pub. No.: US 2015/0181666 A1
(43) Pub. Date: Jun. 25, 2015

(54) ARRANGEMENT AND METHOD FOR CONTROLLING LIGHT-EMITTING DIODES IN ACCORDANCE WITH AN INPUT VOLTAGE LEVEL, BY MEANS OF A CAPACITOR AND SWITCH

(71) Applicant: ZENTRUM MIKROELEKTRONIK DRESDEN AG, Dresden (DE)

(72) Inventor: Erhard Muesch, Werne (DE)

(21) Appl. No.: 14/412,234

(22) PCT Filed: Jul. 1, 2013
(86) PCT No.: PCT/EP2013/063808

§ 371 Date: Dec. 31, 2014

(30) Foreign Application Priority Data
Jul. 4, 2012 (EP) 12174995.6
Jan. 31, 2013 (DE) 10 2013 100 992.1
Mar. 28, 2013 (EP) 13169481.2

(51) Int. Cl. H05B 33/08

(52) U.S. Cl. CPC H05B 33/0809; H05B 33/0845

(57) ABSTRACT

An arrangement and a method for controlling an array of light-emitting diodes includes a capacitor arranged in series with an electronic switch between one end of a first segment of the array and a constant-current source. A first terminal of the capacitor is connected to the one end and a second terminal of the capacitor is connected to the switch. The switch is connected to a control unit for control purposes. The second terminal of the capacitor is connected to the constant-current source via an additional switch and to one end of a subsequent segment of the array, and, by the connection of the additional switch, to a control unit for control purposes

The invention relates to an arrangement for actuating light-emitting diodes, comprising an input, to which an AC input voltage can be applied, and an array of LEDs connected in series, which array is connected to the outputs of the arrangement for actuating light-emitting diodes and is divided into at least two segments, and wherein each segment of the array is connected at one end at least indirectly to a constant current source.

The invention also relates to a method for actuating light-emitting diodes, in which an array of light-emitting diodes connected in series is provided, which array is divided into segments, wherein each segment can contain a plurality of light-emitting diodes and has a first connection and a second connection, and wherein the array is operated on a rectified AC input voltage (VDC) in such a way that the segments are switched on and off successively depending on the amplitude of the AC input voltage (VDC).

LEDs (light-emitting diodes) are increasingly used for lighting purposes since they have a number of advantages over conventional light-emitting means such as incandescent lamps or fluorescent lamps, in particular a low energy requirement and a longer life. Owing to their semiconductor-typical current-voltage characteristic, it is expedient to operate LEDs using a constant current.

During operation of light-emitting means comprising LEDs from a lighting mains, therefore, circuitry measures need to be taken in order to produce the required constant direct current with the low voltage of typically 3 . . . 4 V per LED from a high AC voltage supply, which may have voltage values of 230 VAC, for example. These values can typically apply to so-called white LEDs and may be different for other LEDs.

In addition to the widespread use of so-called AC-to-DC converters, which usually consist of a rectifier and a switched mode power supply, a method is known in which an array of LEDs connected in series is actuated directly from the rectified AC voltage via one or more linear current sources.

This arrangement is also referred to as direct AC LED. For this purpose, advantageously the LED array can be divided into segments, which are energized individually or connected in series corresponding to the instantaneous AC voltage. The number of LEDs connected in series and therefore the forward voltage of the entire LED array is thus configured such that it corresponds to a notable proportion of the amplitude of the mains voltage, which may be in the region of 80 to 90% of the amplitude of the mains voltage, for example.

The voltage drop across the linear current source is therefore kept low, which results in a comparatively high degree of efficiency. At a relatively low instantaneous voltage, only part of the LED array, corresponding to the arrangement-side segmentation of the LEDs, is likewise actuated with a relatively low voltage drop across the associated current source. As a result, the angle of current flow is increased within a half-period, which results in more uniform light emission. Optionally, the current from the linear current source or current sources can be modulated corresponding to the instantaneous mains voltage in order to increase the power factor, i.e. to keep the harmonics content of the supply current low.

Advantages of this known method over the use of AC-to-DC converters are the smaller structural form and lower costs of the drive electronics and improved EMC (electromagnetic compatibility) of the arrangement since no quick switching edges occur.

A principle disadvantage consists in the high degree of ripple of the light emission at twice the mains frequency, which sensitive people find bothersome. Even when there is constant energization of the LEDs, the light emission is reduced when fewer segments than are arranged in the LED array are active.

If the instantaneous voltage at which the LED arrays are actuated falls below the forward voltage of the first segment of the arrays, the current becomes zero, i.e. there are two gaps in each period in which there is no energization of the LEDs. In contrast to the filament of an incandescent lamp, which has considerable thermal inertia and therefore damps the ripple of the power supplied, the light emission of an LED follows the current practically without any delay. In particular these energization gaps can result in an impression of flicker of the lighting which is found to be unpleasant.

A further disadvantage in terms of circuitry in respect of the actuation consists in that the switchover thresholds of the individual segments need to be matched to the number of LEDs per segment and the actual forward voltage.

Thus, the object of the invention consists in specifying an arrangement and method for actuating light emitting diodes whereby improved actuation of the LEDs is achieved without the efficiency and/or the harmonic content being impaired.

In an arrangement for actuating light-emitting diodes, it is therefore proposed that a capacitance is arranged in a series circuit with an electronic switch between one end of a first segment (for example LED-S3) and the constant current source, wherein a first connection of the capacitance is connected to the end and a second connection of the capacitance is connected to the switch, in that the switch is connected, for actuation, to a control unit, that the second connection of the capacitance is connected, via a further switch, to the constant current source and to one end of a segment (for example LED-S4) following the first segment, and that the further switch is connected, for actuation, to a further control unit.

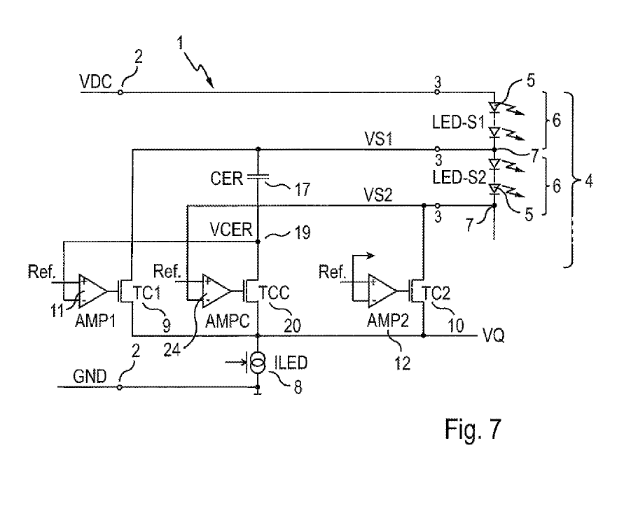

With reference to an example of a circuit shown in FIG. 7, charging of the capacitance CER takes place, when an electronic switch TCC is switched on, via the path of the input of the AC input voltage VDC, the LED segment LED-S1, the capacitance CER itself, the closed electronic switch TCC and the constant current source ILED, which is connected to the second input GND of the actuation arrangement 1 and the ground potential thereof. This charging operation begins with the case where the AC input voltage VDC has exceeded the forward voltage of the segment LED-S1. During charging of the capacitor CER, the potential at the node VCER between the capacitor CER and the electronic switch TCC also increases, which results in the switch TC1 arranged between the end of the first segment LED-S1 and the constant current source ILED being switched off.

The charging of the capacitor CER is continued until the forward voltage of the segments LED-S1 and LED-S2 is exceeded. For this case, the switch TCC is opened and the charge remains on the capacitance CER.

In order to improve the flicker index, the opening of the switch TCC is advantageous, but is not absolutely essential for implementing the invention per se.

The charge collected on the capacitance CER is used for closing the current gaps occurring at twice the line frequency. These occur when the AC input voltage VDC falls below the forward voltage of a single segment. The arrangement is dimensioned in such a way that the voltage V_{CER} on the capacitor CER is greater than the forward voltage of an LED segment. In the current gaps, the capacitor is now connected to an LED segment (LED-S4) by means of a suitable switch (TER) or else only to one or more LEDs within the LED segment, wherein the capacitor CER is discharged via the LED segment or the LEDs and said LEDs illuminate. By virtue of this light emission from the LEDs during the time of a current gap in which there is no light output in accordance with the prior art, the ripple of the light emission is improved.

Further configurations provide for charging a plurality of capacitors and therefore supplying a voltage to a plurality of LED segments or LEDs in the current gaps. Alternatively, the capacitors can be connected in series so as to increase the resultant voltage in the current gaps and therefore, for example, an LED segment or individual LEDs can be caused to illuminate at a higher forward voltage.

A further possibility consists in the use of a current limitation or current regulation arrangement in the discharge circuit. In this way, by appropriate dimensioning of the current regulation, the energy stored in the capacitor or the capacitors is output uniformly and as long as the forward voltage of the LEDs permits this, completely during the current gap. In addition, such regulation of the brightness and the illumination duration of the LEDs is possible.

In a configuration of the invention, it is provided that a second capacitance is arranged in a second series circuit with an electronic switch between one end of a subsequent segment and the constant current source.

In addition to a first capacitance, a second capacitance is introduced into the arrangement, and this capacitance is likewise charged for the case where the amplitude of the AC input voltage VDC is sufficiently high. This second capacitance is connected in series with the first capacitance in the current gaps by means of a suitable arrangement of switching elements, wherein the voltages across the capacitances add up V_{CER1}+V_{CER2}=V_{GES}. By virtue of this measure, an LED segment can be operated in a current gap even for the case where a voltage V_{CER1} or V_{CER2} on a Single capacitance does not reach the magnitude of the forward voltage of the LED segment.

Alternatively, it is also possible for only one LED or a plurality of LEDs within an LED segment to be operated in this embodiment.

In a method for actuating light-emitting diodes, it is proposed that in the event that a preset switch-on threshold of the AC input voltage (VDC) is exceeded, a charging operation of at least one capacitance, fed by the AC input voltage (VDC), is started, and that, in the event that a second switching threshold of the AC input voltage (VDC) is undershot, discharge of the capacitance takes place via a segment.

The method provides for charging of a charging capacitor above a threshold value. For this purpose, a comparison between the AC input voltage and the switch-on threshold which was previously assigned a voltage value takes place. However, the method does not absolutely require this comparison. Alternatively, a connection of a charging capacitor to one end of an LED segment results in not only a current flow through the segment (LED-S1) itself and the further switching elements thereof, but also a charging current for the capacitance CER being generated once the forward voltage for the element in question has been reached. For this purpose, the end of the segment LED-S1 is connected to a constant current source ILED via a closed switch TC1. The capacitance CER is also connected to this constant current source ILED via a closed switch TCC in parallel therewith. By means of suitable actuation of the switched TC1 and TCC, it is ensured that the following LED segments (LED-S2, LED-S3, . . . ) can also be operated with an increasing AC input voltage VDC, and that the charge can be kept at the capacitor CER.

For the case where the AC input voltage VDC falls below a second switching threshold, which is preset prior to the method sequence, the charged capacitor CER is connected to an LED segment in such a way that the charge of the capacitor CER is discharged via the LEDs in the segment and, by virtue of this discharge current, a light emission of the LEDs takes place.

In one embodiment of the invention, it is provided that the switch-on threshold is at a higher voltage value for the AC input voltage (VDC) than the second switching threshold.

The method can detect the case of the forward voltage of the first segment LED-S1 being undershot and can therefore start the capacitor discharge via this or another segment. In order to charge the capacitor CER, it is necessary that the AC input voltage (VDC) has exceeded at least the value of the forward voltage of the first segment LED-S1.

In another embodiment of the invention, it is provided that the discharge of the capacitance takes place only via some of the LEDs arranged in the segment.

In addition to the possibility of switching all of the LEDs in a segment into the discharge circuit of the capacitance, in accordance with the method also only some of the LEDs in the segment can be included. This can be advantageous, for example, for the case where the voltage V_{CER} on the capacitance CER does not reach the magnitude of the forward voltage of the segment containing a plurality of LEDs.

The invention will be explained in more detail below with reference to an exemplary embodiment. In the associated drawings:

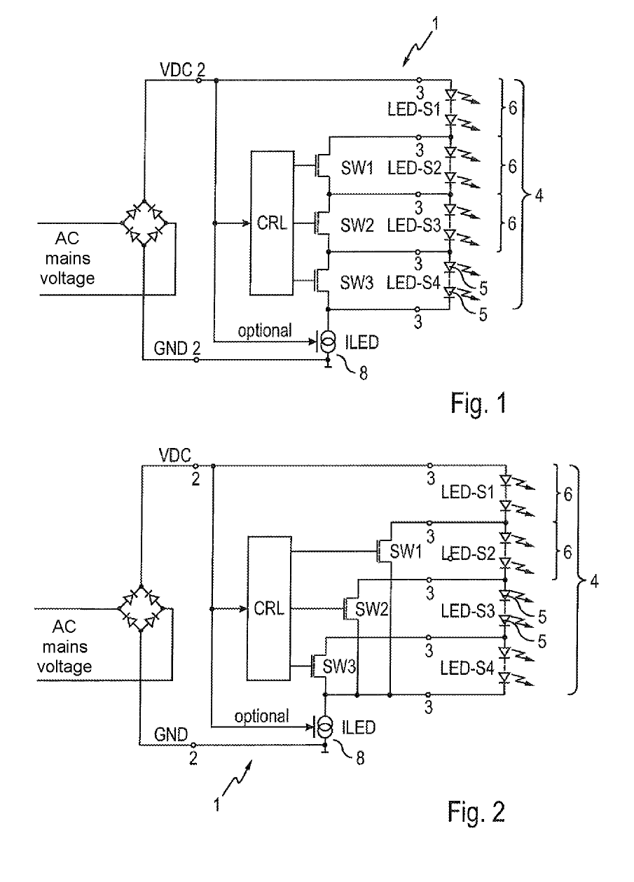

FIG. 1 shows a possible embodiment of an arrangement for actuating light-emitting diodes in accordance with the prior art in a variant as “direct AC LED drivers”,

FIG. 2 shows another possible embodiment of an arrangement for actuating light-emitting diodes in accordance with the prior art in a variant as “direct AC LED drivers”,

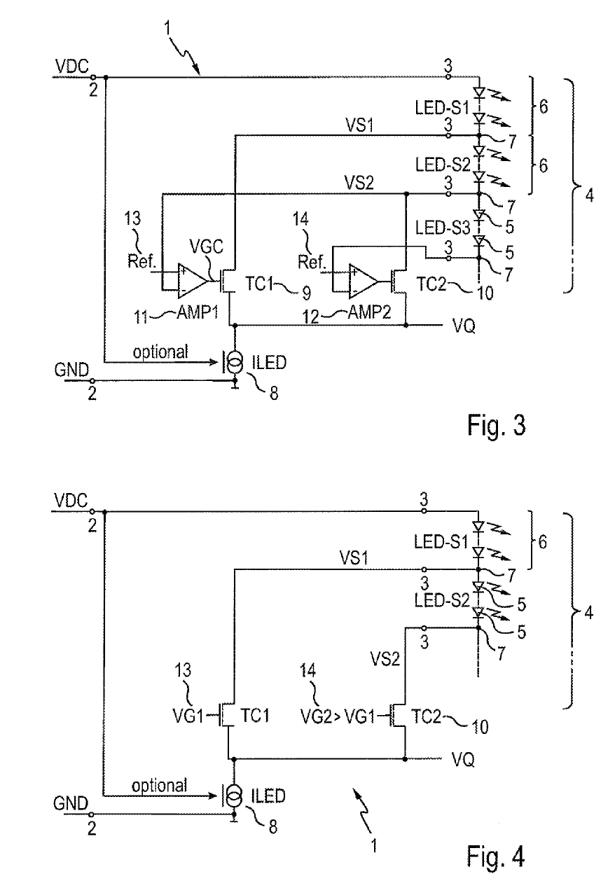

FIG. 3 shows a circuit arrangement according to the invention for actuating light-emitting diodes comprising automatic matching of the current paths to the forward voltage of the LED segments,

FIG. 4 shows a further circuit arrangement according to the invention for actuating light-emitting diodes comprising alternative automatic matching with graded gate voltages,

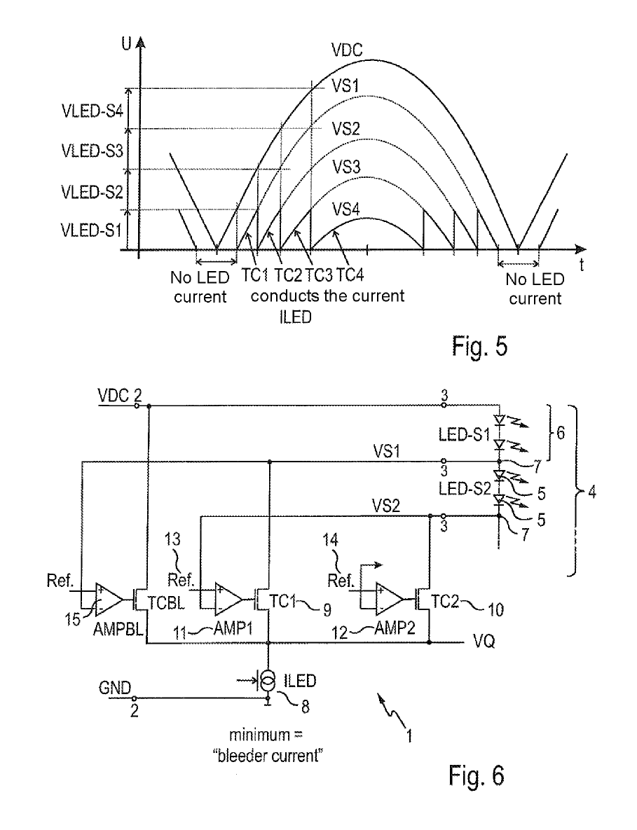

FIG. 5 shows an illustration of the voltage profiles of the rectified mains voltage and the segment voltages over a half-period,

FIG. 6 shows a circuit arrangement for automatic control of a “bleeder current”,

FIG. 7 shows a circuit arrangement for automatic control of charging of an “energy reserve capacitor” CER,

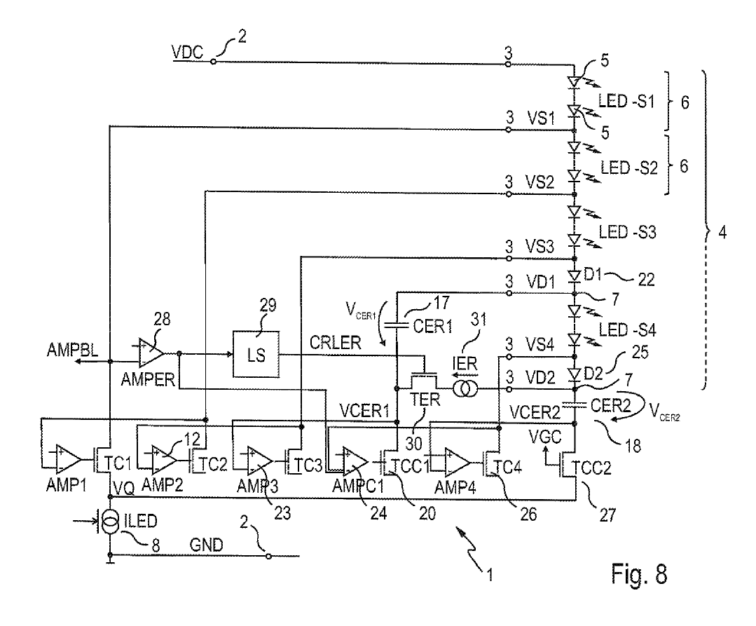

FIG. 8 shows a circuit arrangement for automatic control of the charging and discharging operation of, for example, two capacitors CER1 and CER2,

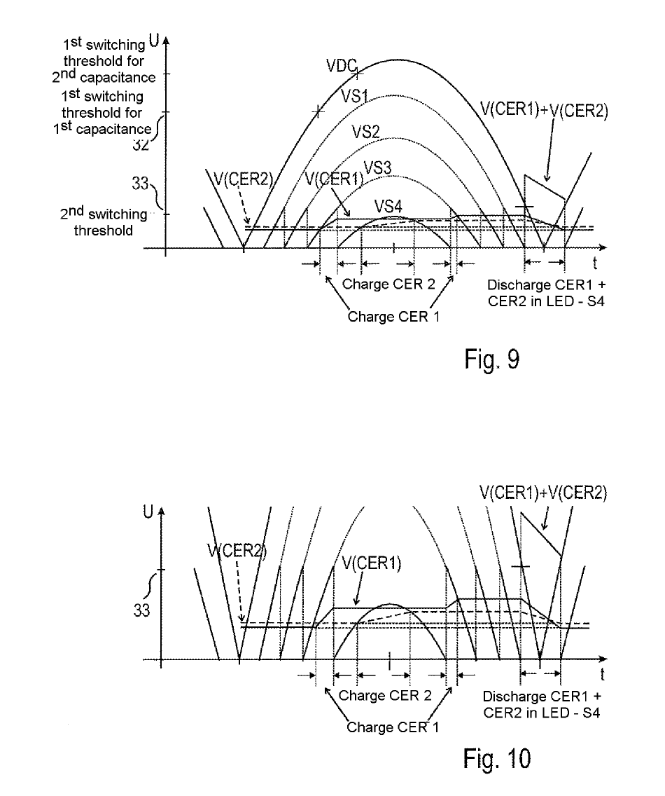

FIG. 9 shows an illustration of the voltage profiles at the capacitors CER1 and CER2 over a half-period, and

FIG. 10 shows an enlarged detail of the illustration of the voltage profiles from FIG. 8.

FIGS. 1 and 2 show two possible embodiments of an arrangement 1 for actuating light-emitting diodes 5 in accordance with the prior art. So-called direct AC LED drivers each having four LED segments 6, which are denoted by LED-S1 to LED-S4, are illustrated. The array 4 is fed from the rectified mains voltage VDC 2, wherein a ground-side current source 8 ILED generates a constant current.

In the illustration shown in FIG. 1, the segments 6 are short-circuited by the switching elements SW1 to SW3, which can be embodied as MOSFETs, for example, corresponding to the instantaneous voltage present across the array 4.

In the configuration shown in FIG. 2, the segment taps 7 are connected to the common current source 8 ILED corresponding to the instantaneous voltage across the array 4 by means of the switching elements SW1 to SW3. A control unit CRL serves the purpose of distributing the current among the number of segments 6 appropriately for the instantaneous voltage. The current source 8 ILED can optionally be modulated corresponding to the instantaneous mains voltage VDC.

The automatic matching of the switching thresholds to the forward voltage of the segments in accordance with the invention will be described below.

FIG. 3 shows the principle using the example of three segments 6 LED-S1 to LED-S3 of an LED array 4 comprising any desired number of LEDs 5 in the respective segment 6. The number of segments 6 can be increased as desired, which is illustrated by a dash-dotted line at the connection 7 of the segment 6-LED-S3 in the figure. Likewise, the number of LEDs 5 per segment 6 is freely selectable.

The anode of the “upper” LED 5 of the segment LED-S1 6 is connected to the supply voltage VDC 2, i.e. the rectified mains voltage. Each segment 6 of the array 4 has a first and a second connection 7. In FIG. 3, the first connection of the first segment 6 is connected to the voltage VDC. The second connection 7 of the first segment 6 is connected to the first connection of the following segment 6 of the array 4. In addition, this second connection 7 is connected to a switching means 9, 10, . . . .

The entire LED array 6 is fed from a common ground-side current source 8 ILED via these switching means 9, 10 which can be switched on and off. Above the current source 8, there are so-called cascode elements TC1 and TC2 9, 10, formed by MOSFETs, bipolar transistors or IGBTs, for example, as switching means for each current path n. A series circuit of two transistors, wherein the “lower” transistor (in the case of an n-channel or NPN transistor) performs the function of control, while the “upper” transistor is used for increasing the dielectric strength and/or the output impedance, is referred to as a cascode.

n stages within the arrangement, which each comprise an n-th LED segment 6 and at least one n-th switching means 9 or 10, are formed in such a way. The first stage comprises the first segment 6 of the array 4 and the first switching means 9. In addition, another element actuating the first switching means 9 can also be included. In the example shown in FIG. 3, this is a first comparator or amplifier 11 AMP1.

The cascode elements 9, 10 limit the voltage VQ across the current source 8 and take up some of the difference between the instantaneous VDC and the forward voltage of the active segments 6 of the LED array 4. The gate or base voltage VGC applied to the cascode elements 9, 10 determines the maximum voltage VC. It is advantageous for automatic threshold adaptation to keep this voltage low.

If the voltage VDC 2 increases starting from a value less than the forward voltage of the segment LED-S1 6, first the segment LED-S1 6 will begin to conduct current when the forward voltage is reached. If the current limited by the current source 8 has been reached and VQ has reached the value limited by the cascode element 9, 10, on a further increase in the VDC 2, the segment voltage VS1 increases, while VQ remains approximately constant.

First there is no current flowing through the segment LED-S2 6, and the segment voltage VS2 approximately corresponds to the voltage VQ.

If VDC reaches the sum of the forward voltages of LED-S1 6 and LED-S2 6, LED-S2 6 also begins to conduct, and the current is divided between TC1 9 and TC2 10. The summation current is furthermore determined by the common current source ILED. On a further increase in VDC 2, the voltage VS2 now increases in comparison with VQ. This increase indicates that LED-S2 6 is conducting, and the current path via TC1 9 can be disconnected. The disconnection can take place, for example, via an amplifier or comparator 11 AMP, whose comparison value is a settable magnitude above the voltage VQ. In order to avoid oscillations around the switching point, it is advantageous to provide a comparator 11 with a hysteresis. This applies in particular to the case where MOSFETs with a relatively high resistance are used as cascode elements 9, 10. When using bipolar transistors, the base current of said bipolar transistors needs to be limited.

Gradual disconnection, for example by means of an amplifier or a simple inverter with a gradual amplification in place of the comparator, is advantageous for avoiding possible noise emission owing to the switchover operations.

Takeover of the current by TC2 10 without switching of TC1 9 is likewise possible by virtue of a control voltage VG2>VG1 being applied, as illustrated in FIG. 4. When the segment LED-S2 6 becomes conducting, TC2 10 increases the voltage VQ and TC1 9 is automatically turned on. The voltage difference between VG2 14 and VG1 13 needs to be sufficiently high for TC1 9 to turn off safely, however, which is particularly important when integrating and using MOSFETs with a relatively high resistance.

In the case of a relatively large number “n” of LED segments, this can result in a considerable “scatter” of the controlling gate voltages VG1 to VGn. Therefore, the combination of graded actuation voltages with the disconnection of proceeding current paths is advantageous.

If the LED array 4 consists of more than two segments 6, the described procedure is repeated with a further increase in VDC 2 for the subsequent stages or current paths n+1, n+2 . . . etc. For the “last” segment 6 of the array 4, a cascode element 9, 10 is not absolutely necessary, but is advantageous in terms of circuitry for limiting the voltage VQ. This last cascode element 9, 10 does not need to be switched. FIG. 3 illustrates, by way of example, two cascode elements 9 and 10.

Once VDC 2 has exceeded its amplitude and there is a decrease in the voltage again, the cascode elements 9, 10 are activated again in the reverse order corresponding to the instantaneous voltage with the same circuitry.

FIG. 5 shows the voltage profiles during a half-period using the example of an LED array 4 consisting of four segments 6 with the same number of LEDs 5. In the illustration, no LED 5 is operated in the region around the zero crossing of the grid-side AC voltage 2 and there is no LED current flowing. Over the further course of time of a positive half-cycle, the voltage VDC 2 increases until the forward voltages of the LEDs 5 in the segment VLED-S1 6 is reached, current is flowing through the segment VLED-S1 6 and this segment 6 therefore illuminates. Over the further course of the positive half-cycle, the voltage VDC 2 continues to increase until the forward voltages of the LEDs 5 in the segments VLED S1 6 and VLED S2 6 are reached. After this time, current also flows through the segment VLED-S2 6, which now likewise illuminates.

This procedure is illustrated further until all segments 6 VLED-S1 to VLED-S4 have current flowing through them and illuminate. Once the maximum of the voltage VDC 2 has been reached, this voltage decreases sinusoidally, which results in the forward voltage of the segment VLED-S4 6 no longer being reached. This results in an interruption of the current flow in the segment VLED-S4 6 and therefore in disconnection thereof. Then, the segments VLED-S3 6, VLED-S2 6 and VLED-S1 6 are disconnected successively, as a result of which there is no longer a current flowing through the array 4.

The embodiment with identical segments 6 can be advantageous for the provision of an application, but is not a precondition for the functionality of the method. The voltage drop VQ across the current source 8 has not been included in the illustration for reasons of better understanding.

FIGS. 3, 4 and 6 show the constant current source 8 with a control input, via which the constant current can be controlled. Thus, the current profile of the constant current source can optionally be matched to the for example sinusoidal current profile of the rectified pulsating input voltage VDC by means of the input voltage VDC 2. This matching results in an improvement of the so-called power factor owing to the reduction of disruptive harmonics.

For operation of an LED luminaire using a dimmer, which operates by means of a phase-gating method (triac) or phase-chopping method (MOSFET or IGBT), a current path needs to be provided for charging a capacitor, which determines the current flow angle within a half-cycle of the mains voltage.

The previously described circuit 1 only conducts current when the forward voltage of the first LED segment 6 has been reached and only then can the time-determining capacitor be charged. Without further measures, therefore, the maximum current flow angle that can be achieved with a dimmer is reduced. In order to avoid this shortening, it is advantageous to design an additional current path which is already active when the mains voltage VDC is still lower than the forward voltage of the first segment 6, for example LED-S1.

This current is referred to as “bleeder current” since it is not used for actuating the LEDs 5 themselves. In FIG. 6, the circuit shown in FIG. 4 has been extended by a cascode or switching element TCBL 16 and a comparator or amplifier 15 AMPBL in accordance with the same principle. The bleeder current flows until VDC has exceeded the forward voltage of the segment LED-S1 6. In this case, the voltage VS1 increases and the comparator 15 AMPBL deactivates the bleeder path. While TCBL 16 is active, the current source ILED 8 provides the bleeder current.

The polarity of the described topology can be reversed, i.e. the current source 8 is then connected to the positive supply voltage (VDC) 2 and the cathode of the “lowermost” LED 5 is connected to the negative supply (GND). It is likewise easily possible for a high-side current source to be controlled by a ground-side or floating-potential current sensor.

The filling of the so-called current gaps in accordance with the invention during actuation of the LEDs is described below with reference to the circuit arrangement shown in FIG. 7.

As soon as a cascode element 9 conducts the current of the current source ILED 8 in the event of an increase in the voltage VDC 2, as described previously, the voltage drop thereof increases corresponding to the difference between the voltage VDC and the summation voltage of the active segment(s) (LED-S1, . . . ) until the next cascode element 10 takes over the current. This current flow in the linear range of the element 9 can be used to charge a capacitor 17. The charging voltage can be up to the forward voltage of the “next” segment (for example LED-S2) without the summation current and the current flow in the LED segments 6 being impaired. This charging operation can be performed for a single cascode element or for a plurality of cascode elements 9, 10 with a corresponding plurality of capacitors 17, which are not illustrated in FIG. 7.

If the capacitor 17 has not been charged up to the forward voltage of the next segment 6 (for example LED S2) during the rising edge of the voltage VDC, it can be charged further during the falling edge of the voltage VDC as long as the voltage difference between the instantaneous voltage VDC and the voltage across the capacitor 17 is still greater than the voltage across the capacitor 17 itself.

The distribution of the current between the “regular” path for operating the LEDs 5 of the segments 6 and the path for charging the capacitor 17 or a further capacitor, advantageously takes place in accordance with the same method as has been previously described for automatic matching to the forward voltages of the LED segments 6.

In this case, the capacitor 17 behaves in the same way as a segment with variable voltage. FIG. 7 shows a corresponding circuit detail for an energy reserve capacitor CER and two LED segments LED-S1 and LED-S2. Once the voltage VDC has exceeded the forward voltage of the first segment LED-S1 6, the voltage VS1 increases and the capacitor CER 17 is charged via the cascode element TCC 20. As long as VDC increases more quickly than the voltage across the capacitor CER 17, the potential at the node VCER 19 is also increased, and the first control unit AMP1 11 switches off the first switch TC1 9, and the total current of the current source ILED 8 is used for charging the capacitor CER 17.

If the increase in voltage of VDC is insufficiently steep for the capacitor CER 17 to be able to take up the total current, the voltage at the node VCER 19 is reduced, and the switch TC1 9 becomes active. Linear actuation of the switches 9, 10 and 20 embodied as cascode elements is particularly advantageous here in comparison with switching using comparators in order to avoid switching to and fro of the current between the electronic switches TCC 20 and TC1 9, for example.

If the voltage VDC reaches the sum of the forward voltages of the segments LED-S1 6 and LED-S2 6, the voltage VS2 increases and the charging operation of the capacitor CER 17 is terminated. The switch TC1 9 has either already switched off or is switched off by the increase in voltage at the node VCER 19. If necessary, the voltage VS2 can also additionally be used in order to deactivate the switch TC1 9.

If all of the LED segments 6 are active, a capacitor can be charged from the difference between the AC input voltages VDC and the sum of the forward voltages of the segments V_{LED} (V_{LED}=V_{LED-S1}+V_{LED-S2}+V_{LED-S3}+ . . . V_{LED-Sx}). Since the profile of the mains voltage in the region of the amplitude is quite flat and therefore the time available for charging a capacitor (for example CER 17) is relatively long, a comparatively large amount of charge can be accumulated on the capacitance here.

It is not absolutely necessary to stop the charging operation of a capacitor (for example 17) when the next LED segment 6 (for example LED-S2) becomes active, but rather a capacitor 17 can also be charged in parallel with two or more segments 6. This simplifies the circuitry complexity involved, but also increases the flicker index, i.e. the relative ripple of the luminous flux, based on the waveform of the total current ILED.

In one embodiment, which is illustrated in FIG. 8, in addition to this first capacitor 17 a second capacitor 18 is arranged in the circuit and is charged in the manner described above.

Some of the energy stored in the capacitor 17 or in the capacitors 17 and 18 can be used to reduce the ripple of the luminous flux occurring at twice the line frequency, specifically to close the energization gap which arises when the voltage VDC falls below the forward voltage of an individual segment 6 (LED-S1). For this purpose, it is necessary for the capacitor voltage to be higher than the forward voltage of at least one LED segment 6. Depending on the dimensions of the circuit, it may be necessary to connect the capacitors 17, 18 in series with one another during the discharge operation.

A possible arrangement with four segments (LED-S1 to LED-S4) and two capacitors 17 and 18, which are charged sequentially and discharged in series for filling the current gap, is shown in FIG. 8. In order to simplify the illustration, the bleeder current has not been taken into consideration in FIG. 8. It goes without saying that this circuit part known from FIG. 6 can also be used in the arrangement shown in FIG. 8.

As the voltage VDC increases, first the cascode elements TC1 9, TC2 10 and TC3 21 become conductive successively, and the current of the constant current source ILED 8 flows through the segments 6 LED-S1, LED-S1+LED-S2 and LED-S1+LED-S2+LED-S3, in the same order. If the voltage VS3 reaches the voltage still remaining at the capacitor CER1 17 plus the diode forward voltage of the diode D1 22, a charging current is fed into the capacitor CER1 17 and, in the case of a further increase in the voltage VDC, the voltage V_{CER1} across the capacitance CER1 also increases. The control unit AMP3 23 turns on the switch TC3 21, and the total current of the current source ILED 8 is available for charging the capacitor CER1 17.

A precondition for this is that the change in voltage dVDC/dt is greater than the change dV_{CER1}/dt in the case of the current ILED 8. The capacitor CER1 17 therefore needs to be selected to be sufficiently large. If this condition is not met, the current of the current source ILED 8 is divided between the cascode elements TC3 21 and TC1 20, and only so much current is used for charging the capacitance CER1 17 that dV_{CER1}/dt and dVDC/dt are identical. The energization of the LEDs 5 of the segment 6 is not influenced by this, however.

If after a further increase in the voltage VDC, the forward voltage of the segment 6 LED-S4 is also exceeded, the charging operation of the capacitance CER1 17 is ended by a switching operation of the control unit AMPC1 24 and switch TCC1 20. Until the voltage. V_{CER2} remaining on the capacitance CER2 18 plus the diode forward voltage of the diode D2 25 has been reached, the switch TC4 26 conducts the current of the current source ILED 8. Then, the operation described above for the switches TC3 21 and TCC1 20 in the cascode elements TC4 26 and TCC2 27 is repeated, and the capacitance CER2 18 is charged. This charging operation is ended when the voltage VDC has fallen so far back again, once its amplitude has been exceeded, that the diode D2 25 turns off. Then, the switch TC4 26 again takes over the current of the current source ILED 8. The cascode element TCC2 27 does not need to be actuated, but can be continuously active. This can be achieved, for example, by virtue of the fact that the gate of this MOSFET switch 27 is connected to the voltage VDC. The diodes D1 22 and D2 25 prevent the discharge of the capacitors CER1 17 and CER2 18 in the case of a falling edge of voltage VDC.

The charges accumulated in the capacitances CER1 17 and CER2 18 are used, by way of example, in order to energize the segment 6 LED S4 as soon as the voltage VDC falls into the range or below the forward voltage of the segment 6 LED-S1. The control signal required for this purpose is obtained in the same way as has already been described above for the actuation of the bleeder current and has been illustrated in the associated FIG. 6.

In one embodiment, possibly the units AMPER 28 for controlling the energy reserve and AMPBL 15 can be combined to form one unit. A stage for level matching LS 29 controls, using a control signal CRLER, a switching element TER 30, which connects the capacitors CER1 17 and CER2 18 in series with one another. The segment 6 LED-S4 is now fed from the summation voltage of the two capacitors 17 and 18. The current is defined via a current source IER 31. The current source IER 31 can be arranged in the discharge path at any desired point. The discharge of the capacitances 17 and 18 connected in series by means of the switch TER 30 takes place beginning from the first connection of the capacitance 17 via the LEDs 5 of the segment LED-S4 6 and the fifth switch TC4 26, the sixth switch TCC2 27 to the second connection of the second capacitor CER2 18 and from the first connection of this capacitor 18 further via the current source IER 31, the switching element TER 30 to the second connection of the first capacitor 17.

Combining the current source IER 31 with the switching element TER 30 in terms of circuitry can be advantageous in particular for an integrated solution.

FIG. 9 illustrates, by way of example, the voltage profiles at the capacitances CER1 17, CER2 18 and the summation voltage (V_{CER1}+V_{CER2}) when the capacitances 17 and 18 are connected in series with one another.

FIG. 9 illustrates, in the background, the segment voltages (VDC, VS1, VS2, VS3 and VS4) as are already known from FIG. 5. For better understanding, only the lower region of the voltage-time profile shown in FIG. 9 is illustrated in enlarged form in detail in FIG. 10.

For this example, it is assumed that the capacitance CER2 18 is greater than the capacitance CER1 17. This assumption is not necessary for the function of the circuit, however.

The dimensioning of the constant current source for the discharge current IER 31 should take place in such a way that, in the case of a minimal supply voltage VDC, the summation voltage at the end of the discharge operation is even higher than the forward voltage of the segment 6 LED-S4. This ensures that the current remains constant at a maximum level during the entire gap and the efficiency of the circuit in relation to the selected topology of the LEDs 5 is at a maximum.

Since more charge can be stored in the capacitor CER2 18 in the case of a higher supply voltage VDC, control of the current of the source IER 31 depending on the level of the supply VDC or the voltage difference between VDC and the forward voltage of the LED array 4 is also advantageous.

By way of example, the discharge operation ends when the voltage VDC is again high enough for the segment 6 LED-S1 to be energized. A discharge operation which is extended on both sides can be expedient if the current of the source ILED 8 is controlled in order to improve the power factor, i.e. in order to reduce the harmonic content in the line current depending on the instantaneous voltage VDC, and the current in the segment 6 LED-S1 is initially lower than the current of the source IER 31. Since the available charge in the capacitances CER1 17 and CER2 18 is limited, the current of the source IER 31 needs to be reduced if the discharge time is extended.

The described operation is repeated in each half-period.

Alternatively embodiments are as follows:
a further segmentation of at least one LED segment 6, with the result that the voltage of a single capacitor 17 is sufficient for energizing a subsegment of this type,
different forward voltages of the segments 6 of an LED array 4, with the result that the voltage of an individual capacitor 17 is sufficient for energizing a segment 6 with a relatively low forward voltage,
a separate LED 5 or LED array 4 which is energized from the energy reserve,
the use of the energy reserve for energizing a different LED segment than the last LED segment 6.

### LIST OF REFERENCE SYMBOLS

1 LED actuation arrangement
2 Input
3 Outputs
4 LED array
5 LED
6 Segment
7 Connection/end
8 Constant current source
9 First electronic switch
10 Second electronic switch
11 First control unit
12 Second control unit
13 First reference voltage
14 Second reference voltage
15 Comparator/amplifier for “bleeder current” AMPBL
16 Switching element TCBL
17 First charging capacitor (CER or CER1)
18 Second charging capacitor (CER2)
19 Node VCER
20 Third electronic switch
21 Fourth electronic switch
22 Diode D1
23 Third control unit
24 Fourth control unit
25 Diode D2
26 Fifth electronic switch
27 Sixth electronic switch
28 Comparator/amplifier AMPER
29 Level matching
30 Switching element TER
31 Current source IER
32 Switch-on threshold
33 Second switching threshold

1. An arrangement for actuating light-emitting diodes, comprising an input, to which an AC input voltage can be applied, and an array of LEDs connected in series, the array being connected to outputs of the arrangement for actuating light-emitting diodes and being divided into at least two segments, and wherein each segment of the array is connected at one end at least indirectly to a constant current source,
wherein: a capacitor is arranged in a series circuit with an electronic switch between one end of a first segment of said array and the constant current source, a first connection of the capacitor is connected to the one end and a second connection of the capacitor is connected to the switch the switch is connected, for actuation, to a control unit, the second connection of the capacitor is connected, via a further switch, to the constant current source and to one end of a subsequent segment of the array following the first segment, and in that the further switch is connected, for actuation, to a further control unit.

2. The arrangement as claimed in claim 1, further comprising a second capacitor is arranged in a second series circuit with an electronic switch between one end of the subsequent segment of the array and the constant current source.

3. A method for actuating light-emitting diodes, in which an array of light-emitting diodes connected in series is provided, the array being divided into segments, wherein each segment contain a plurality of light-emitting diodes and has a first connection and a second connection, and wherein the array is operated on a rectified AC input voltage (VDC) in such a way that the segments are switched on and off successively depending on amplitude of the rectified AC input voltage (VDC), wherein, if a preset switch-on threshold of the rectified AC input voltage (VDC) is exceeded, a charging operation of at least one capacitor, fed by the rectified AC input voltage (VDC), is started, and, if a second switching threshold of the rectified AC input voltage (VDC) is undershot, discharge of the at least one capacitor takes place via a segment of the array.

4. The method as claimed in claim 3, wherein the preset switch-on threshold is at a higher voltage value for the rectified AC input voltage (VDC) than the second switching threshold.

5. The method as claimed in claim 3, wherein the discharge of the at least one capacitor takes place only via some of the LEDs arranged in the segment.

6. The method as claimed in claim 4, wherein the discharge of the at least one capacitor takes place only via some of the LEDs arranged in the segment.
